(19) United States
(12) Patent Application Publication
(10) Pub. No.: US 2009/0144936 A1
(43) Pub. Date: Jun. 11, 2009

(54) Hinge Assembly

(76) Inventor: Jr-Jiun Chern, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/953,957

(22) Filed: Dec. 11, 2007

(51) Int. Cl. E05D 1/04

(52) U.S. Cl. 16/337

(57) ABSTRACT

A hinge assembly comprises a first and a second coupling member adapted to connect to a notebook computer. The first and second coupling member are pivotally moveable with respect to one another such that the notebook computer can be moved between an open and a closed position. A positioning member is moveable in concert with the second coupling member and includes a plurality of detents. A first biasing device includes a first member having a plurality of indentations adapted to receive the corresponding detents and adapted to be rotatably moved with respect to the positioning member, and a second member formed with a predetermined curvature, wherein the predetermined curvature is reduced when the plurality of detents disengages from the corresponding indentations. A second biasing device is biasably moved with respect to the first biasing devices for enabling a pivot angle between the first and second coupling members securely retained.

### BACKGROUND OF THE INVENTION

1. Field of the Invention

The present invention relates to a hinge assembly, in particular to a hinge assembly for use in a notebook computer.

2. Description of the Related Art

The use of hinge assemblies for the opening and closing of notebook computer is notoriously well known. While the hinge assemblies provide constant resistance throughout the notebook computer's pivoting range of motion, a primary problem of which the hinge assemblies lose their original tightness and fail to maintain the desired resistance over time has always been a concern in relation to their development.

The present invention is, therefore, intended to obviate or at least alleviate the problems encountered in the prior art.

### SUMMARY OF THE INVENTION

It is therefore an object of the present invention to provide a hinge assembly that securely retains the notebook computer between an open and a closed position.

It is a further object of the invention to provide a hinge assembly which facilitates pivoting of the notebook computer.

Accordingly, the hinge assembly comprises a first and a second coupling member adapted to connect to a notebook computer. The first and second coupling member are pivotally moveable with respect to one another such that the notebook computer can be moved between an open and a closed position. A positioning member is moveable in concert with the second coupling member and includes a plurality of detents formed thereon. A first biasing device includes a first member having a plurality of indentations adapted to receive the corresponding detents and adapted to be rotatably moved with respect to the positioning member, and a second member formed with a predetermined curvature, wherein the predetermined curvature is reduced when the plurality of detents disengages from the corresponding indentations. A second biasing device is biasably moved with respect to the first biasing devices for enabling a pivot angle between the first and second coupling members securely retained. At least one support member or a combination of a support plate and a pivotal member is provided for reinforcing the configuration of the hinge assembly.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a hinge assembly in accordance with a first embodiment of the present invention.

FIG. 2 is a front elevation view of the hinge assembly.

FIG. 3 is an exploded perspective view of the hinge assembly.

FIG. 4 is an exploded perspective view taken from a different angle of view.

FIG. 5 is a cross-sectional view taken along line 5-5 of FIG. 1.

FIG. 6 is a cross-sectional view taken along line 6-6 of FIG. 1.

FIG. 7 is a cross-sectional view taken along line 7-7 of FIG. 5.

FIG. 8 is similar to FIG. 5, but shows the hinge assembly with the first coupling member in another position relative to the second coupling member.

FIG. 9 is similar to FIG. 6, but shows the hinge assembly with the first coupling member in another position relative to the second coupling member.

FIG. 10 is a cross-sectional view taken along line 10-10 of FIG. 8.

FIG. 11 is a partial, enlarged view of the hinge assembly shown in FIG. 2.

FIG. 12 is a perspective view of a hinge assembly in accordance with a second embodiment of the present invention.

FIG. 13 is an exploded perspective view of the hinge assembly of FIG. 12.

FIG. 14 is a cross-sectional view taken along line 14-14 of FIG. 12.

### DETAILED DESCRIPTION OF THE PREFERRED EMBODIMENT

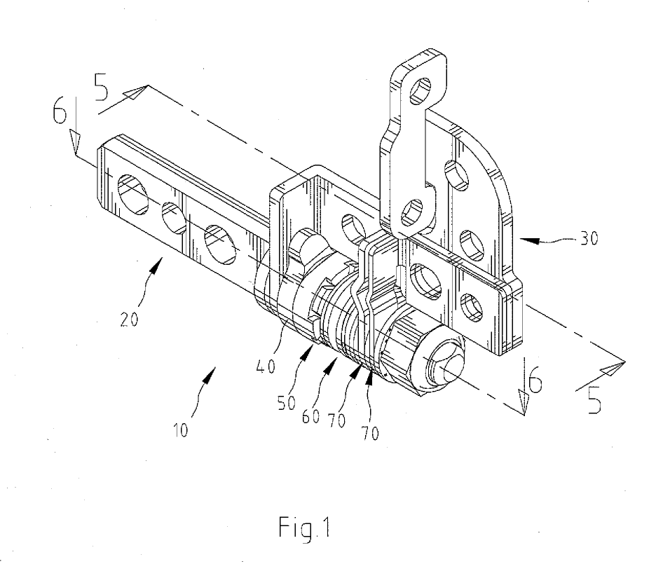

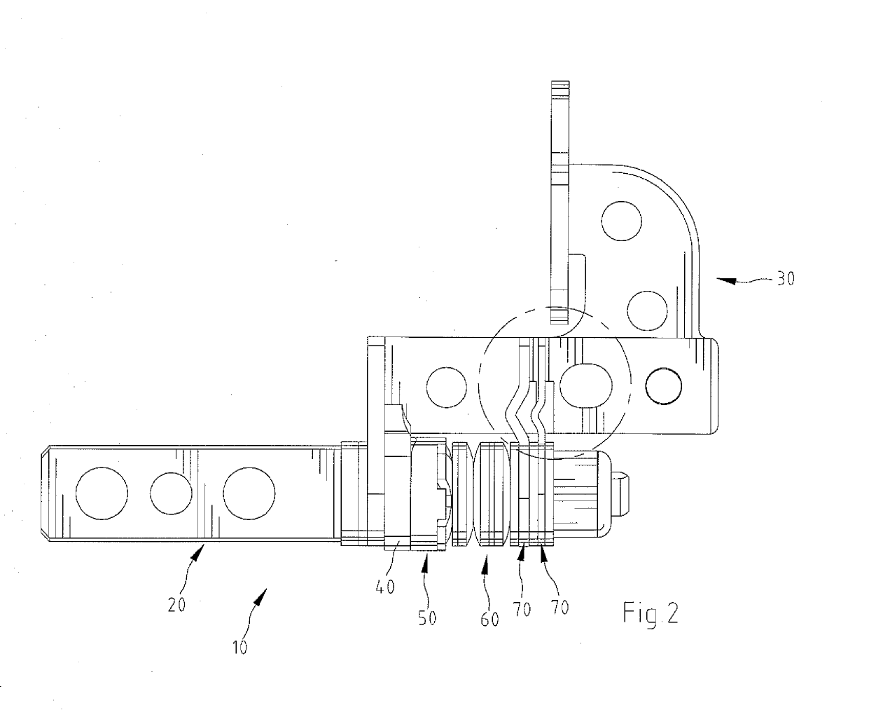

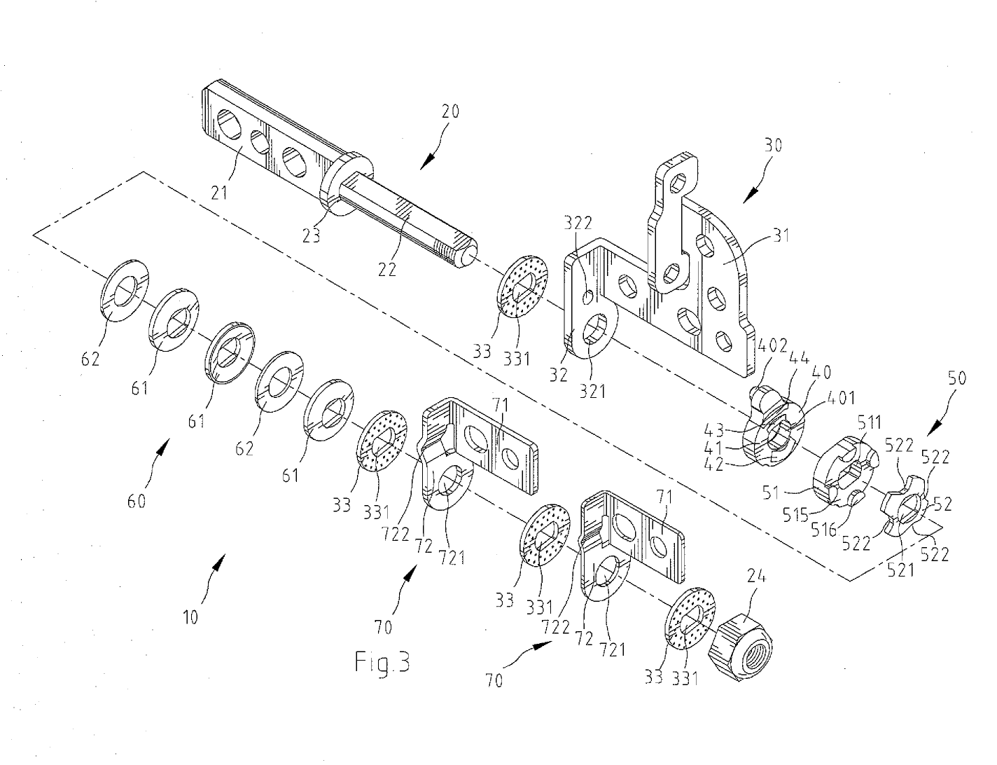

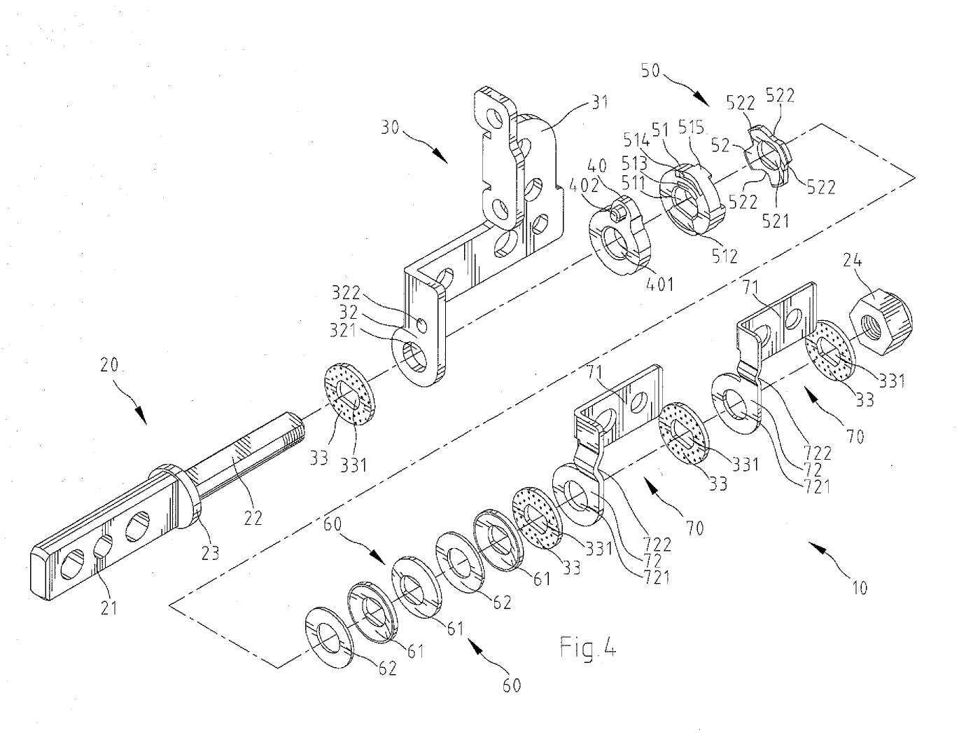

Referring to FIGS. 1 through 4, a hinge assembly 10 for use in a notebook computer includes a first coupling member 20 having a first end 21 for joining with a base of the notebook computer, a non-circular cross-sectional second end 22 for pivotally receiving a second coupling member 30, a positioning member 40, a first biasing device 50, a second biasing device 60, two support members 70 and a threadly fixed end cup 24. Furthermore, a shoulder 23 is integrally formed between the first and second ends 20, 21.

The second coupling member 30 includes a base 31 for joining with a display of the notebook computer and a flange 32 with a hole 321 through which the second end 22 of the first coupling member 20 insertably engages. The second coupling member 30 is rotated with respect to the first coupling member 20. A lubricating washer 33 may be disposed between the shoulder 23 and the flange 32 for reducing friction due to movement of the first coupling member 20 with regard to the second coupling member 30. The lubricating washer 33 has an orifice 331 through which the second end 22 of the first coupling member 20 inserts.

The positioning member 40 includes an orifice 401 through which the second end 22 of the first coupling member 20 inserts. The positioning member 40 also has a first side (not numbered) having a projection 402 thereon adapted to insert into an aperture 322 on the flange 32 and a second side 41 having a first, a second, and a third detents 42, 43 and 44. In this embodiment, the first, second and third detents 42, 43 and 44 are all arcuate and have slops formed at a proximal and distal ends thereof Additionally, the first detent 42 is spaced 180 degrees of rotation apart from the second and third detents 43 and 44 and each detent 42, 43 and 44 is disposed at a different distance with respect to the center of the second side 41 thereof The positioning member 40 is rotated in concert with the second coupling member 30.

The first biasing device 50 includes a first member 51 and a second member 52 having associated orifices 511, 521 through which the second end 22 of the first coupling member 20 inserts. The first member 51 has a first surface (not numbered) on which formed a first, a second and a third indentations 512, 513 and 514 that receive the first, second and third detents 42, 43, and 44 correspondingly. The indentations 512, 513 and 514 each includes a proximal and distal ends of a slope configuration, which not only facilitate the reception of the associated detent but also prevent the detent from being easily disengaged therefrom. The first member 51 further has a second surface 515 from which extended four equally distributed stubs 516 that are receivable in four recessed edges 522 defined by the second member 52 correspondingly. The second member 52 is formed in a shape of a dome with predetermined curvature. The first biasing device 50 is rotated with respect to the first coupling member 20.

The second biasing device 60 includes a plurality of disk shaped resilient rings 61 and a plurality of spacers 62, wherein one spacer 62 is disposed between two resilient rings 61 whose outermost peripheral edges are coupled to each other.

The support members 70 are provided for reinforcing the configuration of the hinge assembly 10. The support members 70 include bases 71 and flanges 72 overlapped to each other. The support members 70 are attached to the base 31 of the second coupling member 30 such that the support members 70 move in concert with the second coupling member 30. Furthermore, the overlapped flanges 72 include overlapped orifices 721 through which the second end 22 of the first coupling member 20 inserts. Each flange 72 also includes a ridge section 722 with a V-shaped cross section. In this preferred embodiment, one of the support members 70 is of a size smaller than the other. The support member 70 of larger size has its base 71 attached to the base 31 of the second coupling member The support members 70 are disposed between the second biasing device 60 and the end cap 24. A lubricating washer 33 may be disposed between the second biasing device 60 and the overlapped support members 70. A lubricating washer 33 may be disposed between the flanges 72. A lubricating washer 33 may be disposed between the overlapped support members 70 and the end cap 24.

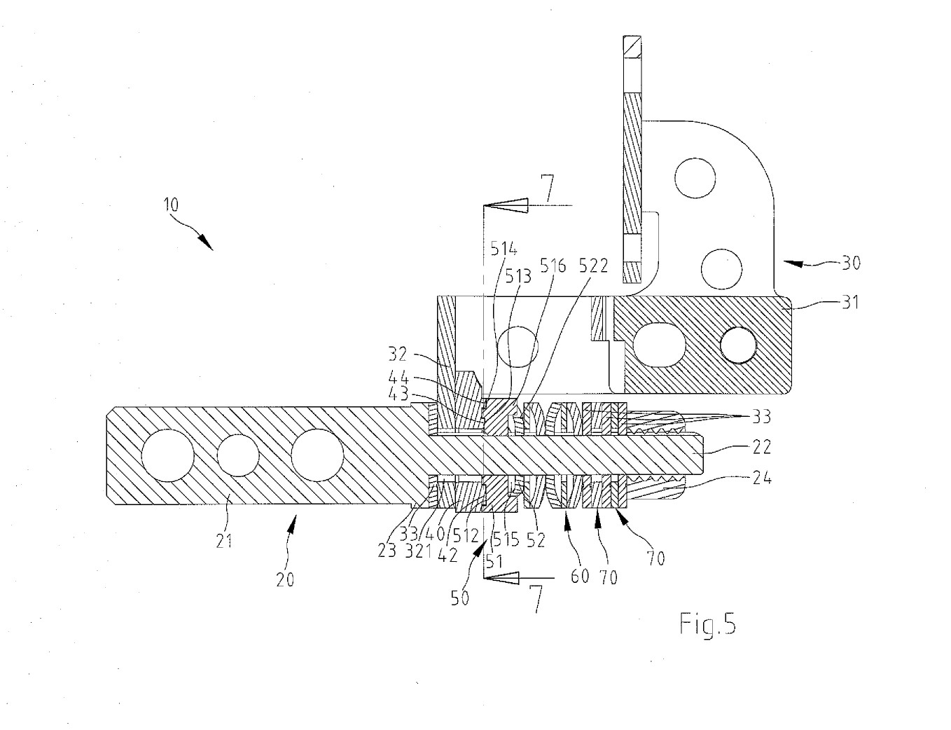

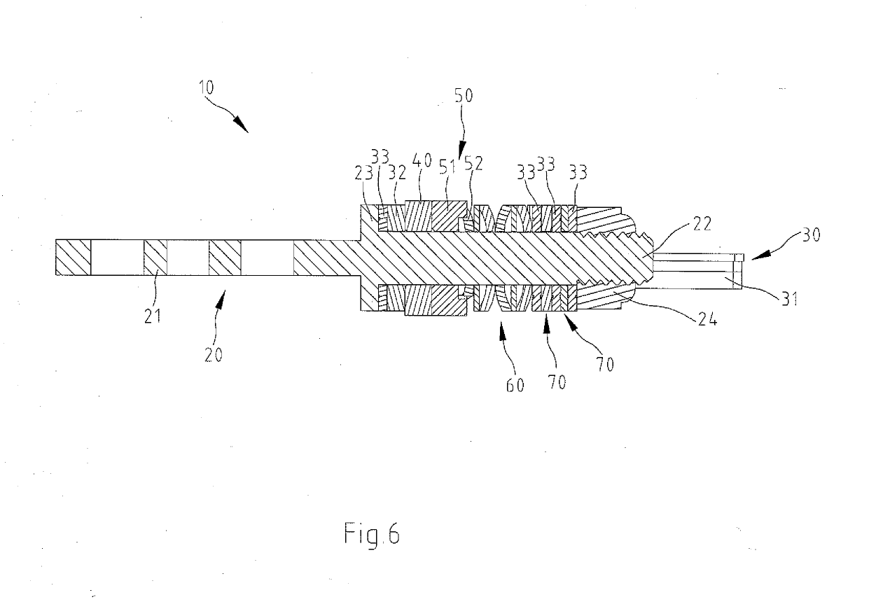

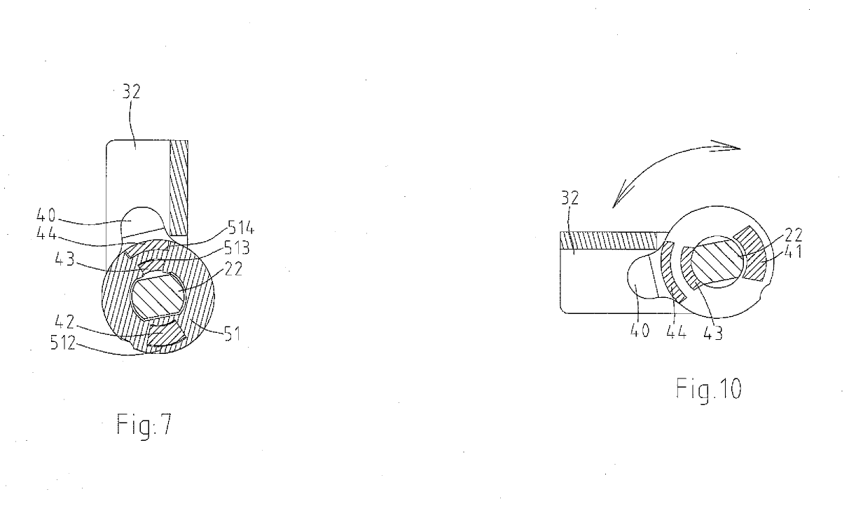

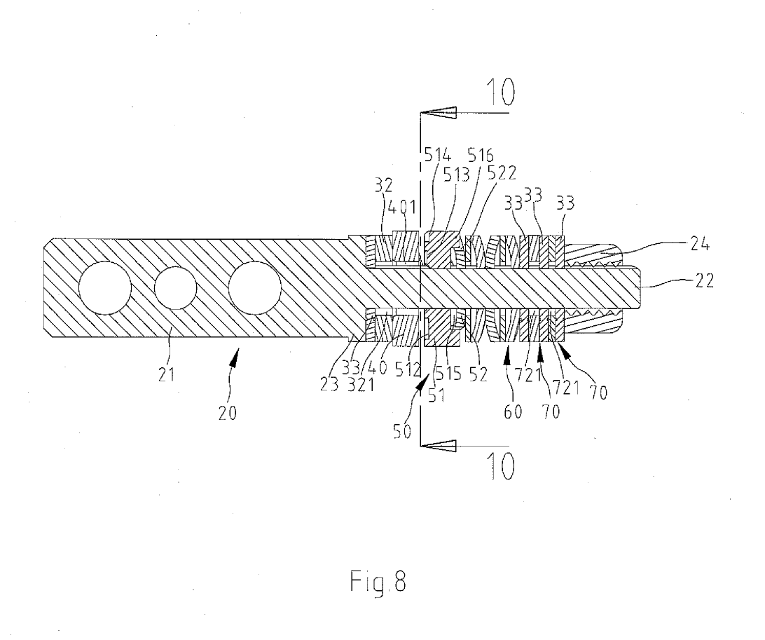

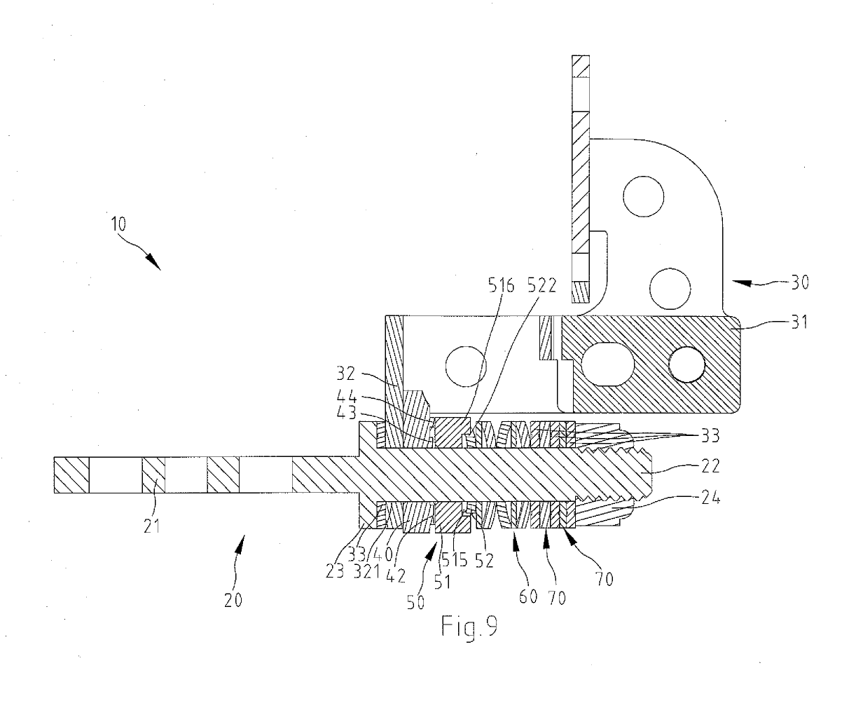

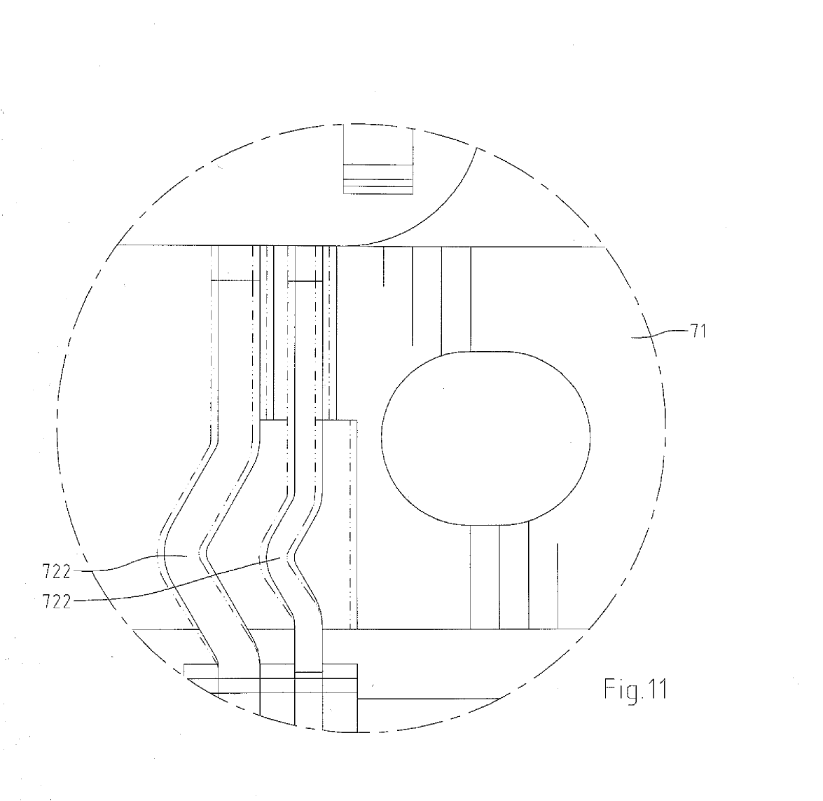

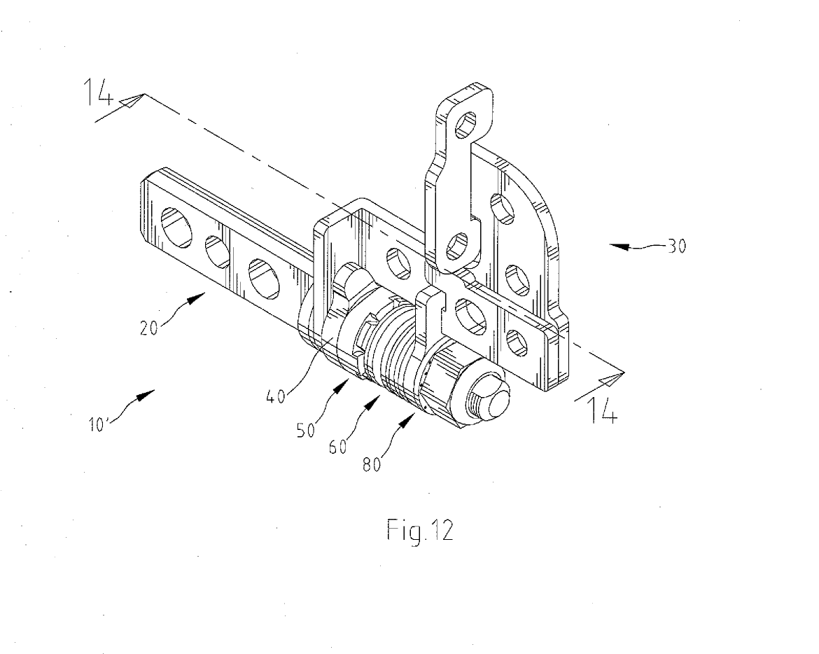

In a closed state of the hinge assembly 10, as best shown in FIGS. 5 through 7, the first, second and third detents 42, 43, and 44 are received in the first, second and third indentations 512, 513 and 514 correspondingly. Referring to FIGS. 8 through 11, when the first and second coupling member 20, 30 are rotated with respect to each other, the detents 42, 43, and 44 are rotated to disengage from the respective indentations 512, 513 and 514, the first biasing device 50 is then urged and the predetermined curvature of the second member 52 is reduced, and the flange 72 of the support members 70 are tilted in a manner that the wall of the orifices 721 remains aligned with the second end 22 of the first coupling member 20, as best shown in FIG. 11. Moreover, with respect to such a configuration, the pivot angle between the first and second coupling member 20, 30 is securely retained.

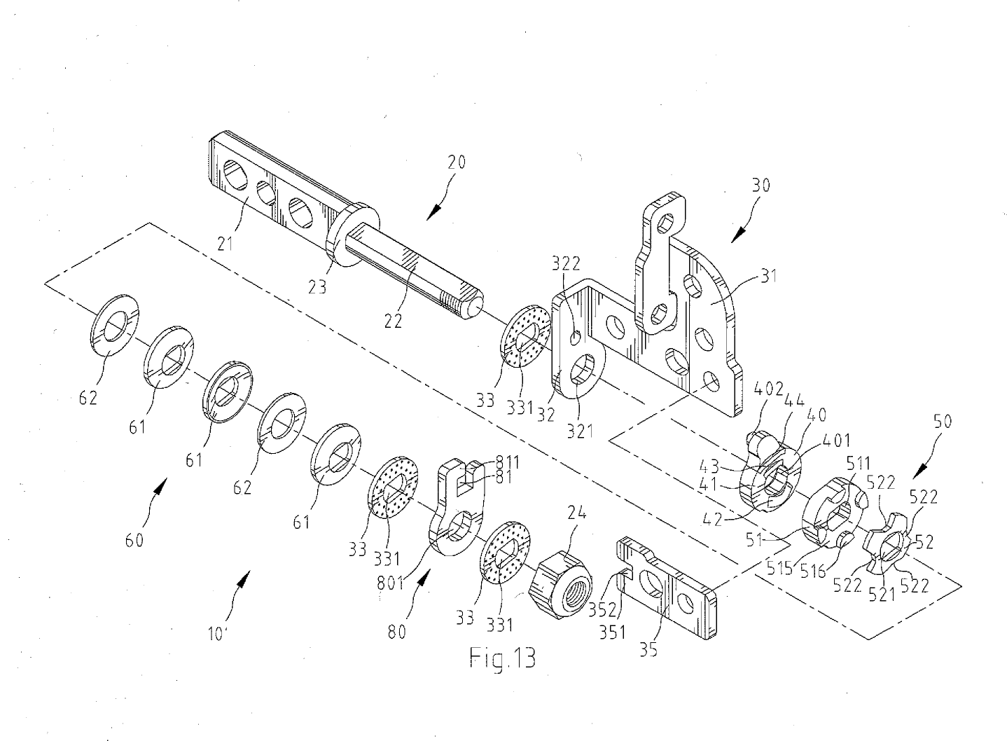

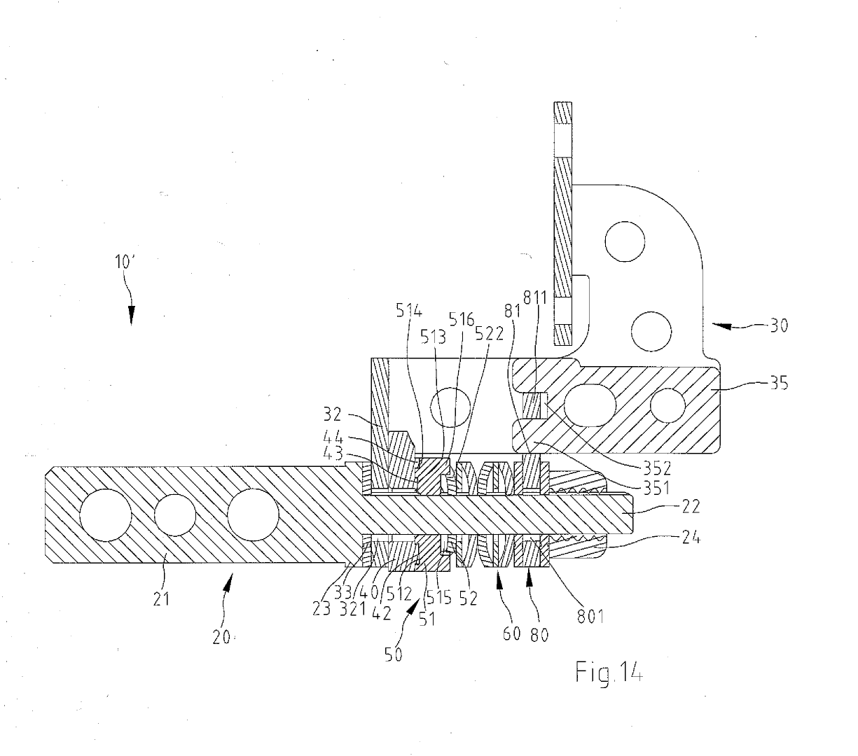

FIGS. 12 to 14 show an alternate embodiment of a hinge assembly 10′ in accordance with the present invention. The hinge assembly 10′ is similar to prior embodiment but the support members 70 are omitted and replaced by a support plate 35 and a pivotal member 80. The support plate 35 is attached to the base 31 of the second coupling member 30 and includes two lugs 351 and a notch 352 therebetween. The pivotal member 80 includes a slot 81 for engaging the support plate 35 and the coupling member 30 at a side thereof, an orifice 801 which the second end 22 of the first coupling member 20 inserts through, and a latching portion 811 moveably engaged in the notch 352 when the first and second coupling member 20, 30 are rotated with respect to each other. In this embodiment, the notch 352 is formed with a predetermined depth for enabling the pivot angle between the first and second coupling member 20, 30 securely retained.

What is claimed is:

1. A hinge assembly for use in a notebook computer comprising:
a first coupling member including an end adapted to connect to the notebook computer;
a second coupling member which includes a base adapted to connect to the notebook computer, moveable with respect to the first coupling member such that the notebook computer can be moved between an open and a closed position;
a positioning member moveable in concert with the second coupling member and including a side having a plurality of detents formed thereon;
a first biasing device moveable in concert with the first coupling member and including a first member and a second member having a peripheral edge located against the first member, with the first member having a first surface having a plurality of indentations for receiving the corresponding detents, and with the plurality of indentations adapted to be rotatably moved with respect to the said side of the positioning member; and with the second member formed in a shape of a dome with a predetermined curvature, wherein the predetermined curvature is reduced when the plurality of detents disengages from the corresponding indentations; and
a second biasing device biasably moved with respect to the first biasing devices for enabling a pivot angle between the first and second coupling members securely retained.

2. The hinge assembly as claimed in claim 1 further comprising at least one support member including a base fixed to the second coupling member and a flange having an orifice through which the first coupling member insert and a ridge section bent from the flange.

3. The hinge assembly as claimed in claim 2, wherein the ridge section comprises a V-shaped cross section.

4. The hinge assembly as claimed in claim 1, wherein the first member of the first biasing device comprises a plurality of stubs formed thereon, and wherein the second member of the first biasing device includes a plurality of recessed edges to receive the plurality of stubs correspondingly.

5. The hinge assembly as claimed in claim 1 further comprising a support member pivotally mounted to the first coupling member and a support plate fixed to the second coupling member, and the support member is moveably mounted to the support plate.

6. The hinge assembly as claimed in claim 5, wherein the support plate includes a notch and the pivotal member comprises a latching portion moveably engaged in the notch.

7. The hinge assembly as claimed in claim 1, wherein each of the plurality of detents comprises a sloped proximal end and a sloped distal end and each of the plurality of indentations includes a sloped proximal end and a sloped distal end.

8. The hinge assembly as claimed in claim 1, wherein the second biasing device includes a plurality of disk shaped resilient rings and a plurality of spacers.
